(19) United States
(12) Patent Application Publication
(10) Pub. No.: US 2022/0262397 A1
(43) Pub. Date: Aug. 18, 2022

(54) DISK DEVICE

(71) Applicants: KABUSHIKI KAISHA TOSHIBA, Tokyo (JP); TOSHIBA ELECTRONIC DEVICES & STORAGE CORPORATION, Tokyo (JP)

(72) Inventors: Ryusuke KIMURA, Yokohama Kanagawa (JP); Yasutaka SASAKI, Nakano Tokyo (JP)

(21) Appl. No.: 17/466,897

(22) Filed: Sep. 3, 2021

(30) Foreign Application Priority Data
Feb. 12, 2021 (JP) 2021-020678

(51) Int. Cl. G11B 5/66; G11B 5/588; G11B 5/55; G11B 5/39

(52) U.S. Cl. CPC G11B 5/66; G11B 5/3961; G11B 5/5569; G11B 5/588

(57) ABSTRACT

According to one embodiment, a disk device includes a base, a drive motor, disk-shaped magnetic recording media, a carriage supporting a magnetic head to be movable with respect to the magnetic recording medium, and a plurality of fixing members. The base includes a bottom wall and a side wall having a first corner and a second corner. The fixing member includes a support post erected on the bottom wall, and extending parts each extending from the support post between the magnetic recording media. The fixing members include a first fixing member provided between the magnetic recording medium and the first corner, a second fixing member provided between the magnetic recording medium and the second corner, and a third fixing member provided on a side facing the first fixing member.

### CROSS-REFERENCE TO RELATED APPLICATIONS

This application is based upon and claims the benefit of priority from Japanese Patent Application No. 2021-020678, filed Feb. 12, 2021, the entire contents of which are incorporated herein by reference.

### FIELD

Embodiments described herein relate generally to a disk device.

### BACKGROUND

A hard disk drive (HDD) includes a housing, a drive motor, a disk-shaped magnetic recording medium supported and rotated by the drive motor, and the like.

In order to increase the capacity of the HDD, the number of pieces of magnetic recording media is increasing. As the number of pieces of magnetic recording media increases, the thickness of the magnetic recording medium becomes thinner. Therefore, when an impact is applied to the housing of the HDD from the outside, displacement occurs on the outer peripheral edge of the magnetic recording medium and stress concentrates on the central part of the magnetic recording medium, which may cause the magnetic recording medium to be damaged. As a result, writing to and reading from the magnetic recording medium cannot be performed any more.

In a case in which the magnetic recording medium is formed of glass, displacement occurs on the outer peripheral edge of the magnetic recording medium and stress concentrates on the central part of the magnetic recording medium, which may cause the magnetic recording medium to be broken.

### BRIEF DESCRIPTION OF THE DRAWINGS

FIG. 1 is a perspective view of an HDD according to a first embodiment.

FIG. 2 is a plan view of the HDD.

FIG. 3A is an enlarged perspective view showing a fixing member of the HDD.

FIG. 3B is an enlarged perspective view showing the fixing member of the HDD.

FIG. 4 is a cross-sectional view of the HDD taken along a line A-A in FIG. 1.

FIG. 5A is a perspective view of the fixing member according to a first modification.

FIG. 5B is a perspective view of the fixing member according to a second modification.

FIG. 6 is a cross-sectional view of the HDD including the fixing member according to a third modification.

FIG. 7 is a perspective view of an HDD according to a second embodiment.

FIG. 8 is a plan view of the HDD according to the second embodiment.

FIG. 9A is a diagram showing a stress simulation result in a case in which an angle formed between the fixing members is 87.5°.

FIG. 9B is a diagram showing a stress simulation result in a case in which the angle formed between the fixing members is 100°.

FIG. 9C is a diagram showing a stress simulation result in a case in which the angle formed between the fixing members is 110°.

FIG. 9D is a diagram showing a stress simulation result in a case which the angle formed between the fixing members is 127.5°.

### DETAILED DESCRIPTION

Various embodiments will be described hereinafter with reference to the accompanying drawings.

In general, according to one embodiment, a disk device comprises: a base including a bottom wall and a side wall erected along a peripheral edge of the bottom wall and having a first corner and a second corner; a drive motor provided on the bottom wall; a plurality of disk-shaped magnetic recording media that are supported and rotated by the drive motor; a carriage comprising a head and supporting the magnetic head to be movable with respect to the magnetic recording medium; and a plurality of fixing members that each include a support post erected on the bottom wall and facing an outer peripheral edge of the magnetic recording medium, and a plurality of extending parts each extending from the support post between the magnetic recording media and facing the magnetic recording medium with a gap. The fixing members include: a first fixing member provided between the outer peripheral edge of the magnetic recording medium and the first corner; a second fixing member provided between the outer peripheral edge of the magnetic recording medium and the second corner; and a third fixing member provided on a side facing the first fixing member across the magnetic recording medium.

The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes and the like, of the respective parts are illustrated schematically in the drawings, rather than as an accurate representation of what is implemented. However, such schematic illustration is merely exemplary, and in no way restricts the interpretation of the invention. In addition, in the specification and drawings, the same elements as those described in connection with preceding drawings are denoted by like reference numbers, and detailed description thereof is omitted unless necessary.

### First Embodiment

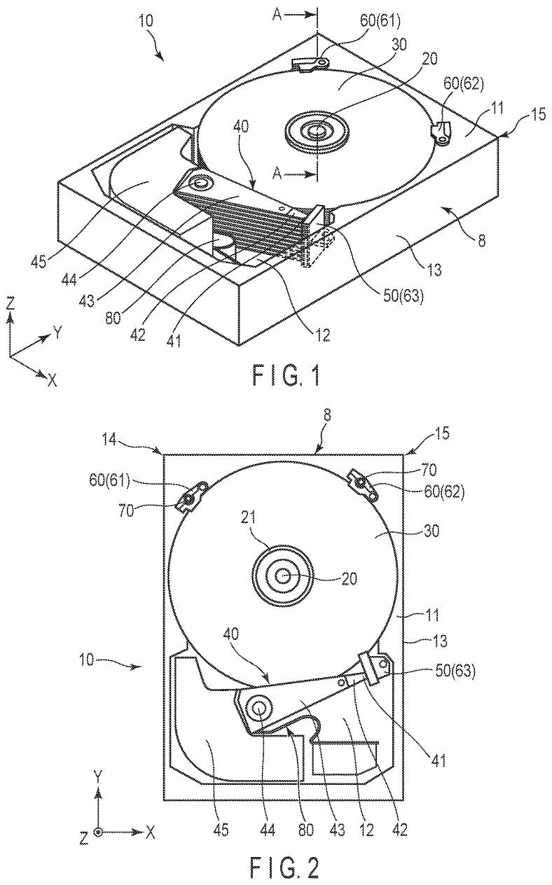

An HDD 10 according to a first embodiment is described. FIG. 1 is a perspective view of an HDD according to the first embodiment, and FIG. 2 is a plan view of the HDD.

As illustrated, the HDD 10 comprises a housing 8 having a rectangular box-shaped base 11 with an opened upper surface and a cover (not shown). The base 11 has a rectangular bottom wall 12 and a side wall 13 erected along a peripheral edge of the bottom wall 12, and is integrally molded. The cover is formed in, for example, a rectangular plate shape, and can be screwed onto the side wall 13 of the base 11 by screws (not shown) to seal the upper opening of the base 11. The housing 8 of the HDD 10 formed by sealing the base 11 with the cover is sealed with an inert gas such as helium (He) having a density lower than that of air. For example, aluminum (Al) is used as the base 11.

In the base 11, a spindle motor 20 (drive motor), a disk-shaped magnetic recording medium 30, a carriage assembly 40, a head 41, a voice coil motor (VCM) 45, a ramp member 50, a plurality of fixing members 60, and a board unit 80 are accommodated.

The spindle motor 20 is attached to the bottom wall 12 of the base 11 and functions as a drive motor. Plural pieces of the disk-shaped magnetic recording media 30 are provided, and supported and rotated by the spindle motor 20. The carriage assembly 40 is movably supported with respect to the magnetic recording medium 30, and is rotated and positioned by the VCM 45. The heads 41 are provided on one end side of the carriage assembly 40, and record and read information on and from the magnetic recording media 30. When the head 41 moves to the outermost periphery of the magnetic recording medium 30, the ramp member 50 holds the head 41 at a retracted position separated from the magnetic recording medium 30. A plurality of the fixing members 60 are provided in the vicinity of the magnetic recording medium 30. The board unit 80 includes a preamplifier and the like.

A printed circuit board (not shown) is screwed to an outer surface of the bottom wall 12 of the base 11. The printed circuit board constitutes a control unit that controls the operation of the spindle motor 20 and also controls the operations of the VCM 45 and the head 41 via the board unit 80.

In FIGS. 1 and 2, a direction along a rotation axis of the magnetic recording medium 30 is defined as a Z direction, a direction along a longitudinal direction of the HDD 10 in a plane perpendicular to the Z direction as a Y direction, and a direction perpendicular to the Z direction and the Y direction as an X direction.

As disk-shaped magnetic recording media, plural, for example, ten pieces of magnetic recording media 30 are arranged in the Z direction. The number of pieces of the magnetic recording media 30 is not limited to ten, and may be nine or less, or eleven or more. Each magnetic recording medium 30 is formed to have, for example, a diameter of 96 mm (about 3.5 inches), includes a base material formed of such as glass or aluminum and magnetic recording layers formed on an upper surface and a lower surface of the base material, and has recording surfaces on both surfaces.

FIG. 4 is a cross-sectional view of the HDD taken along a line A-A in FIG. 1. As illustrated, ten pieces of the magnetic recording media 30 are coaxially fitted into a hub (rotor) of the spindle motor 20, and are stacked in a state in which gaps are maintained in the Z direction by spacer rings 22. The magnetic recording media 30 are clamped by a clamp spring 21 and fixed to the hub. As a result, the magnetic recording media 30 are supported in a state of being positioned parallel to the XY plane. Then, the magnetic recording media 30 are rotated at a predetermined rotation speed by the spindle motor 20.

As shown in FIGS. 1 and 2, the carriage assembly 40 includes a bearing part 44 fixed on the bottom wall 12 of the base 11, eleven pieces of arms 43 extending from the bearing part 44, and an elastically deformable elongated plate-shaped suspension 42 fixed to a tip end of each of the arms 43. The carriage assembly 40 is located near an outer peripheral edge of the magnetic recording medium 30. Eleven pieces of the arms 43 are located in parallel with the recording surface of the magnetic recording medium 30 and at predetermined intervals from each other, and extend in the same direction from the bearing part 44. The suspension 42 is formed of a leaf spring, and a base end thereof is fixed to the tip end of the arm 43 by spot welding, caulking, or the like, and extends from the arm 43. Each suspension 42 may be formed integrally with the corresponding arm 43. Each of eleven pieces of the heads 41 is attached to the suspension 42. Two pieces of the heads 41 arranged between the magnetic recording media 30 face each other and face each recording surface of the adjacent magnetic recording media 30.

When the VCM 45 is energized, the carriage assembly 40 rotates about the bearing part 44 as a base axis, and the head 41 is moved and positioned at a desired position on the surface of the magnetic recording medium 30. As a result, the head 41 can write or read information to or from the magnetic recording medium 30.

The ramp member 50 is provided on the bottom wall 12 of the base 11 and constitutes a third fixing member 63 described later. The ramp member 50 has a plurality of uneven parts in the Z direction by having a plurality of extending parts 67 to be described later. When the HDD 10 is not operated, the head 41 moves away from the outer periphery of the magnetic recording medium 30. At this time, the head 41 is held in a recess of the ramp member 50 as a predetermined stop position.

As shown in FIGS. 1 and 2, the board unit 80 includes a preamplifier (not shown) and a controller (not shown). A tip end of the board unit 80 is connected to the carriage assembly 40, and is electrically connected to the head 41 via a wiring member (not shown). The base end of the board unit 80 is connected to the printed circuit board via a connector (not shown).

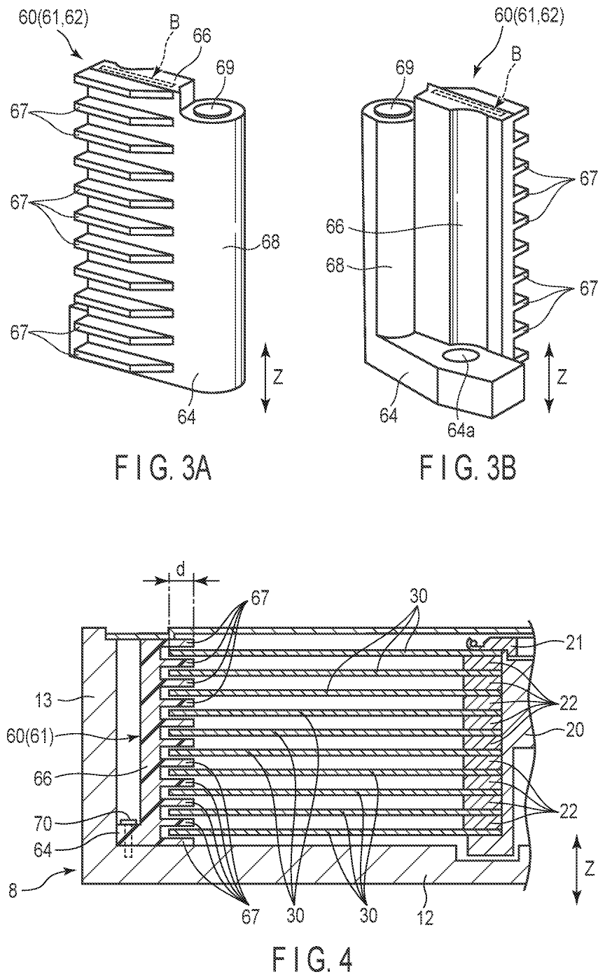

In the present embodiment, three members including a first fixing member 61, a second fixing member 62, and the third fixing member 63 are provided as the fixing members 60 in the housing 8, and are arranged around the magnetic recording medium 30. FIGS. 3A and 3B are perspective views showing one side and the other side of the fixing member, respectively.

As shown in FIGS. 3A and 3B, the fixing member 60 (the first fixing member 61, the second fixing member 62) includes a fixed part 64, a support post 66 and a support shaft 68 extending from the fixed part 64 in the Z direction, and plural pieces of extending parts 67 extending substantially vertically from the support post 66, and is integrally molded such as with a synthetic resin. A through hole 64a through which a fixing screw is inserted is formed in the fixed part 64. A through hole 69 extending in the Z direction is formed to penetrate the support shaft 68.

As shown in FIG. 4, the fixing members 60 are arranged in the vicinity of the magnetic recording medium 30, and are each positioned with respect to the base 11 by having a support pin (not shown) erected on the bottom wall 12 of the base 11 inserted into the through hole 69 of the support shaft 68. By the fixing member 60 rotating about the support pin, plural pieces of the extending parts 67 are inserted between the magnetic recording media 30. The fixing member 60 is fixed to the bottom wall 12 at a predetermined position by having a fixing screw 70 screwed into the bottom wall 12 through the through hole 64a.

The support post 66 is erected in the Z direction. For example, eleven pieces of the extending parts 67 are provided, which extend substantially parallel to the XY plane from the support post 66. The extending parts 67 are arranged substantially parallel to each other at predetermined intervals in the Z direction. Nine pieces of the extending parts 67 positioned between the uppermost extending part 67 and the lowermost extending part 67 in the Z direction each extend between two adjacent magnetic recording media 30 and face the outer peripheral edge of the magnetic recording medium 30 with a gap therebetween. That is, the HDD 10 has a portion in which the lowermost extending part 67, nine pieces of the magnetic recording media 30 and nine pieces of the extending parts 67 alternately arranged, the magnetic recording media 30, and the uppermost extending part 67 are arranged in this order in the Z direction. For example, in the XY plane, the extending part 67 is provided so as to overlap the outer peripheral edge of the magnetic recording medium 30 by a width d of about 0.5 to 1 mm. The gap in the Z direction between the extending part 67 and the outer peripheral edge of the magnetic recording medium 30 is set to, for example, about 0.3 mm.

As shown in FIG. 2, the first fixing member 61 is provided between the outer peripheral edge of the magnetic recording medium 30 and the side wall 13 of the base 11, but is desirably provided at a position where the distance between the outer peripheral edge of the magnetic recording medium 30 and the side wall 13 is small. From the viewpoint of efficiently using the space inside the HDD 10, the first fixing member 61 is desirably provided between a first corner 14 whose distance from the outer peripheral edge of the magnetic recording medium 30 is small among the corners of the base 11 and the outer peripheral edge of the magnetic recording medium 30.

Similarly, the second fixing member 62 is provided between the outer peripheral edge of the magnetic recording medium 30 and the side wall 13 of the base 11, but is desirably provided at a position where the distance between the outer peripheral edge of the magnetic recording medium 30 and the side wall 13 is small. From the viewpoint of efficiently using the space in the HDD 10, the second fixing member 62 is desirably provided between a second corner 15 whose distance from the outer peripheral edge of the magnetic recording medium 30 is small among the corners in the base 11 and the outer peripheral edge of the magnetic recording medium 30.

The third fixing member 63 is provided on the side facing the first fixing member 61 across the spindle motor 20 in the XY plane. As described above, the third fixing member 63 in the present embodiment may also serve as the ramp member 50. Each of the spaces between the plurality of extending parts 67 of the third fixing member 63 is a space in which the outer peripheral edge of the magnetic recording medium 30 is arranged and a space in which the head 41 is held.

The HDD 10 according to the first embodiment may include a filter (not shown). The filter is arranged in the vicinity of the magnetic recording medium 30 and extends in the Z direction along the peripheral edge surface of the magnetic recording medium 30. With this configuration, the filter functions as a circulation filter that collects dust using a flow of air in the housing 10 and a flow of air in the vicinity of the side surface of the magnetic recording medium 30. In order to collect dust in the vicinity of each recording surface of the magnetic recording medium 30 by the flow of air, the filter has a height higher than the stacking height of the magnetic recording medium 30. In addition, the filter is provided near a corner inside the base 11 from a functional and spatial viewpoint.

As shown in FIGS. 3A and 3B, the fixing member 60 (61, 62) may also serve as a filter holder that accommodates the above-described filter. In this case, the fixing member 60 is formed to allow the filter to be stored at a position surrounded by a chain line B of the support post 66.

Functions and effects of the HDD 10 according to the first embodiment is described.

When an impact is applied to the housing 8 of the HDD 10 from the outside, there is a case in which the outer peripheral edge of the magnetic recording medium 30 is displaced in the Z direction. The HDD 10 according to the first embodiment is provided with plural pieces of the fixing members 60. Each fixing member 60 has the plurality of extending parts 67 extending from the support post 66 to the space between two adjacent magnetic recording media 30. Therefore, when an impact is applied to the HDD 10 from the outside, the displacement of the outer peripheral edge of the magnetic recording medium 30 in the Z direction can be suppressed by the extending part 67, and an amount of displacement can be reduced. Therefore, the stress generated in the central part of the magnetic recording medium 30 can be reduced, and damage to the magnetic recording layer of the magnetic recording medium 30 and the base material formed of glass can be suppressed.

In order to suppress the magnetic recording medium 30 from being displaced, for example, it is possible to provide a squeeze plate having an extending part that covers substantially the entire periphery of the outer peripheral edge of the magnetic recording medium 30. However, in the case of a squeeze plate covering substantially the entire periphery of the outer peripheral edge of the magnetic recording medium 30, there is a possibility that a portion is partially generated where the distance between the magnetic recording medium 30 and the extending part is different from other portions. Therefore, when the HDD is operated, there is a risk of wind turbulence occurring between the rotating magnetic recording medium 30 and the extending part to increase disc flutter.

On the other hand, by providing the plurality of fixing members 60 covering a part of the outer peripheral edge of the magnetic recording medium 30 as in the present embodiment, it is possible to suppress variations in the distance between the magnetic recording medium 30 and the extending part 67. Therefore, when the HDD is operated, wind turbulence generated between the rotating magnetic recording medium 30 and the extending part can be reduced. Therefore, the HDD 10 according to the present embodiment can suppress the disk flutter during operation.

As described above, according to the first embodiment, it is possible to obtain the disk device that can suppress generation of stress on the magnetic recording medium and suppressing damage to the magnetic recording medium.

Next, HDDs according to modifications and other embodiments are described. In the modifications and other embodiments described below, the same parts as those of the first embodiment described above are denoted by the same reference numerals as those of the first embodiment, and the detailed description thereof may be omitted or simplified.

### (First Modification)

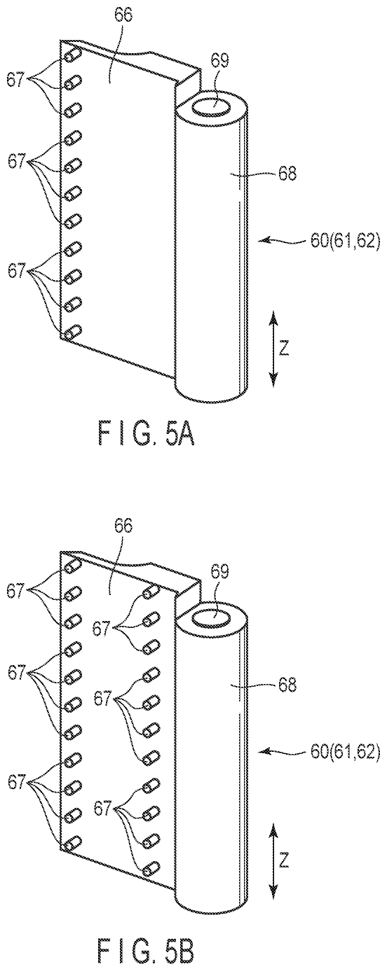

FIG. 5A is a perspective view showing the fixing member 60 according to a first modification.

As shown in FIG. 5A, the fixing member 60 according to the first modification is different from the fixing member of the HDD 10 according to the first embodiment in that the extending parts 67 are each formed in a pin shape. The HDD 10 according to the first embodiment and an HDD according to the first modification have the same configuration except for the shape of the extending part 67.

Because the extending part 67 of the fixing member 60 is formed in a pin shape, an area in which the magnetic recording medium 30 and the extending part 67 face each other is reduced as compared with the case in which the extending part 67 is formed in a plate shape. Therefore, it is possible to further suppress the portion where the distance between the magnetic recording medium 30 and the extending part 67 is different from that of other portions. Therefore, when the magnetic recording medium 30 is rotating, wind turbulence in the vicinity of the magnetic recording medium 30 can be reduced, and the disk flutter in which the magnetic recording medium 30 vibrates with the rotation can be suppressed.

### (Second Modification)

FIG. 5B is a perspective view showing a fixing member 60 according to a second modification.

In the first modification, eleven pieces of the extending parts 67 are arranged in a row in the Z direction so as to allow one piece of pin-shaped extending part 67 to be positioned above and below each magnetic recording medium 30. The pin-shaped extending parts 67 may be provided in plural numbers above and below the magnetic recording medium 30. According to the second modification, as shown in FIG. 5B, each extending part is constituted of two pieces of pin-shaped extending parts 67. Eleven pieces of the extending parts 67 are arranged in two rows in the Z direction.

The accuracy of the distance between the magnetic recording medium 30 and the extending part 67 is better in a case in which one piece of the pin-shaped extending part 67 is provided above and below the magnetic recording medium 30. However, the area that suppresses the displacement of the magnetic recording medium 30 increases by providing the extending parts 67 in plural numbers above and below the magnetic recording medium 30. Therefore, the displacement of the outer peripheral edge of the magnetic recording medium 30 in the Z direction can be more stably suppressed.

### (Third Modification)

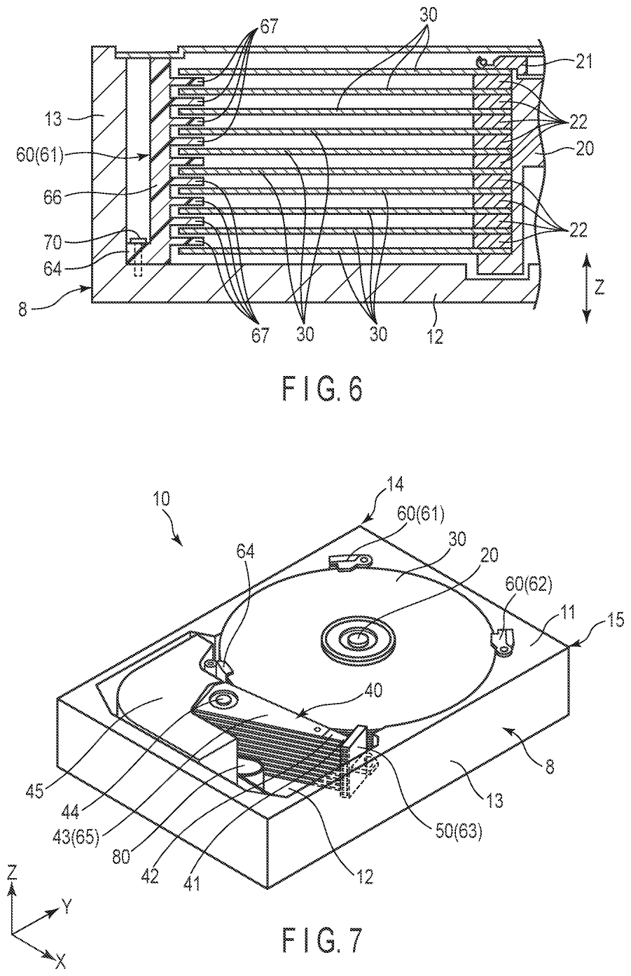

FIG. 6 is a cross-sectional view of the HDD according to a third modification.

The number of the extending parts 67 of the fixing member 60 is not limited to eleven, and may be partially omitted.

As shown in FIG. 6, according to the third modification, because, in particular, the lowermost magnetic recording medium 30 is close to the bottom wall 12 of the base 11, the extending part 67 provided between the lowermost magnetic recording medium 30 and the bottom wall 12 is eliminated. Even in the case of omitting this extending part, it is possible to suppress the displacement in the Z direction occurring at the outer peripheral edge of the magnetic recording medium 30.

Furthermore, unlike the other magnetic recording media 30, the uppermost magnetic recording medium 30 is fixed by a clamp spring 21. The distance between the clamp spring 21 and the outer peripheral edge of the magnetic recording medium 30 is longer than the distance between the spacer ring 22 and the outer peripheral edge of the magnetic recording medium 30. Therefore, in a case in which the displacements in the Z direction generated at the outer peripheral edges of the magnetic recording media 30 are the same, the displacement angle of the uppermost magnetic recording medium 30 with respect to the XY plane is smaller than the displacement angles of the other magnetic recording media 30. Accordingly, in the third modification, the extending part 67 provided on the uppermost magnetic recording medium 30 is eliminated. Even in the case in which the extending part is omitted, the stress generated in the central part of the uppermost magnetic recording medium 30 is smaller than the stress generated in the other magnetic recording media 30, and destruction of the magnetic recording layer of the magnetic recording medium 30 and the base material formed of glass can be suppressed.

Further, in the third modification, the extending part located at the central part in the Z direction is eliminated. Even in the case of omitting this extending part, it is possible to suppress the displacement in the Z direction occurring at the outer peripheral edge of the magnetic recording medium 30.

As described above, with the configuration in which the extending parts 67 are partially omitted, the manufacturing cost of the fixing member 60 can be reduced.

### Second Embodiment

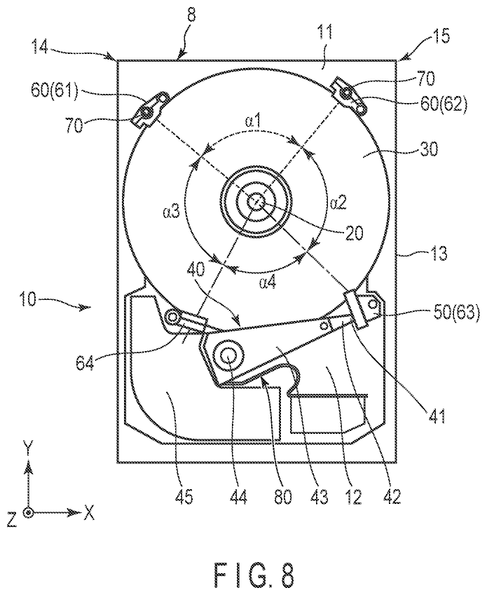

FIG. 7 is a perspective view of an HDD according to a second embodiment, and FIG. 8 is a plan view of the HDD according to the second embodiment.

As illustrated, an HDD 10 according to the second embodiment is different from the HDD 10 according to the first embodiment in that four fixing members 60 are provided on the outer peripheral edges of magnetic recording media 30.

The HDD 10 according to the second embodiment includes, as the fixing member 60, a first fixing member 61, a second fixing member 62, a third fixing member 63, and a fourth fixing member 64. The first fixing member 61 and the second fixing member 62 are similar to the first fixing member 61 and the second fixing member 62 in the first embodiment. Similarly to the first embodiment, the third fixing member 63 also serves as a ramp member 50. In the present embodiment, the fourth fixing member 64 also serves as a spoiler, for example.

The spoiler (fourth fixing member 64) has a function of regulating the flow of air accompanying the rotation of the magnetic recording medium 30, reducing wind turbulence in the vicinity of the magnetic recording medium 30, and suppressing the disc flutter in which the magnetic recording medium 30 vibrates accompanying the rotation. The spoiler includes a plate-shaped main body, a plurality of rectifying plates, and a fixed part, and is integrally molded with such as synthetic resin. The spoiler is arranged in the vicinity of the magnetic recording medium 30, and is screwed and fixed onto a bottom wall 12 of a base 11 by screwing a fixing screw (not shown) into a through hole provided in the fixed part. The plate-shaped main body is formed in the Z direction. For example, eleven pieces of the rectifying plates are provided, extend substantially parallel to the XY plane from the plate-shaped main body, and are arranged at predetermined intervals in the Z direction. Except for the uppermost and lowermost rectifying plates, other nine pieces of the rectifying plates extend between two adjacent magnetic recording media 30, and face the magnetic recording media 30 with a gap therebetween.

In the case of the spoiler also serving as the fourth fixing member 64, the plate-shaped main body of the spoiler is replaced by a support post 66, and the rectifying plate is replaced by an extending part 67.

Similarly to the HDD 10 according to the first embodiment, the first fixing member 61 and the second fixing member 62 may also serve as a filter holder.

At the outer peripheral edge of the magnetic recording medium 30, the second fixing member 62 is adjacent to the first fixing member 61 in the circumferential direction. The first fixing member 61 and the second fixing member 62 are arranged such that an angle α1 formed by a straight line connecting the first fixing member 61 and the center of the magnetic recording medium 30 (that is, a spindle motor 20) and a straight line connecting the second fixing member 62 and the center of the magnetic recording medium 30 is 100° or less.

At the outer peripheral edge of the magnetic recording medium 30, the third fixing member 63 is arranged adjacent to the second fixing member 62 in the circumferential direction. The second fixing member 62 and the third fixing member 63 are arranged such that an angle α2 formed by a straight line connecting the second fixing member 62 and the center of the magnetic recording medium 30 and a straight line connecting the third fixing member 63 and the center of the magnetic recording medium 30 is 100° or less.

At the outer peripheral edge of the magnetic recording medium 30, the fourth fixing member 64 is provided between the third fixing member 63 and the first fixing member 61. That is, the fourth fixing member 64 is adjacent to the third fixing member 63 and the first fixing member 61 in the circumferential direction.

The first fixing member 61 and the fourth fixing member 64 are arranged such that an angle α3 formed by a straight line connecting the first fixing member 61 and the center of the magnetic recording medium 30 and a straight line connecting the fourth fixing member 64 and the center of the magnetic recording medium 30 is 100° or less. The third fixing member 63 and the fourth fixing member 64 are arranged such that an angle α4 formed by a straight line connecting the third fixing member 63 and the center of the magnetic recording medium 30 and a straight line connecting the fourth fixing member 64 and the center of the magnetic recording medium 30 is 100° or less.

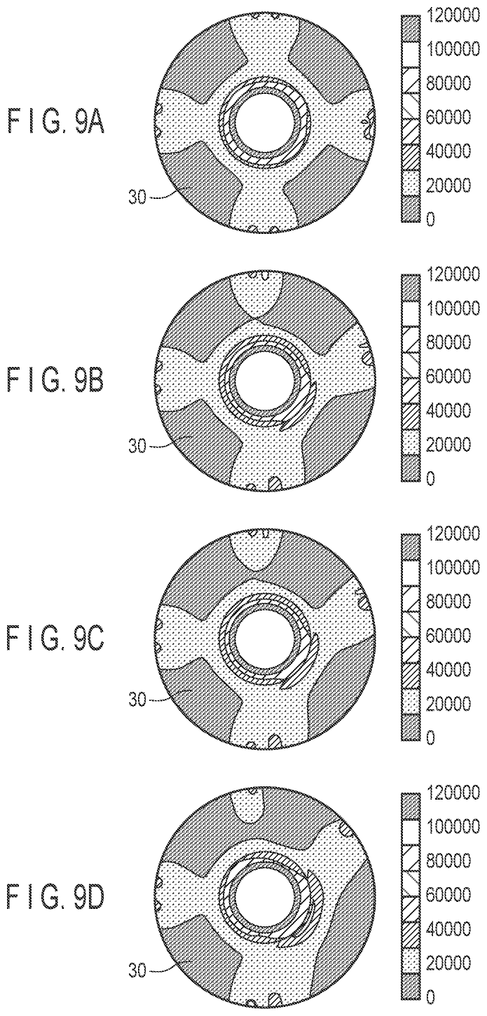

Functions and effects of the HDD 10 according to the second embodiment are described. FIGS. 9A to 9D show simulation results obtained by applying an external force to one piece of the magnetic recording medium 30 and measuring stress applied to the magnetic recording medium 30. FIG. 9A is a diagram showing a stress simulation result in a case in which the angle α formed between the fixing members 60 is 87.5°, FIG. 9B is a diagram showing a stress simulation result in a case in which the angle α is 100°, FIG. 9C is a diagram showing a stress simulation result in a case in which the angle α is 110°, and FIG. 9D is a diagram showing a stress simulation result in a case in which the angle α is 127.5°.

In each simulation, the thickness of the magnetic recording medium 30 in the Z direction is set to 0.635 mm, and the gap between the extending part 67 and the magnetic recording medium 30 in the Z direction is set to 0.3 mm. In addition, the external force applied to one magnetic recording medium 30 is set to 250 G, which is substantially the same as a case in which the external force is actually applied to the HDD 10.

When the stress applied to the magnetic recording medium 30 of the HDD 10 becomes about 95 MPa or more, the magnetic recording layer of the magnetic recording medium 30 is destroyed, and there is a possibility that data cannot be read and written. From the respective simulation results, the stress generated in the case of the angle α formed between the two adjacent fixing members 60 being 87.5° (FIG. 9A) was 75.1 MPa, and the stress generated in the case of the angle α being 100° (FIG. 9B) was 92.6 MPa. On the other hand, the stress generated in the case of the angle α between the two adjacent fixing members 60 being 110° (FIG. 9C) was 99.5 MPa, and the stress generated in the case of the angle α being 127.5° (FIG. 9D) was 114 MPa.

From the above simulation results, it can be seen that the stress applied to the magnetic recording medium 30 tends to reduce when the angle α formed by the two adjacent fixing members 60 is changed from 127.5° to 110°. Therefore, in order to reduce the stress applied to the magnetic recording medium 30, it is desirable to set the angle α formed by the two adjacent fixing members 60 to 120° or less. Furthermore, in order to suppress a value of the stress applied to the magnetic recording medium 30 to 95 MPa, it is more desirable to arrange the fixing members 60 such that the angle α formed by the two adjacent fixing members 60 is 100° or less. Therefore, it is desirable to provide the fixing members 60 at four or more locations in the circumferential direction at the outer peripheral edge of the magnetic recording medium 30.

As described above, by providing the fixing members 60 at four or more locations spaced apart from each other in the circumferential direction at the outer peripheral edge of the magnetic recording medium 30, and arranging the fixing members 60 such that the angle formed between the adjacent fixing members 60 is 100° or less, the damage of the magnetic recording medium and the damage of the magnetic recording layer can be suppressed even when the HDD receives the impact.

Also in the HDD according to the second embodiment, the first modification, the second modification, and the third modification described above can be applied. For example, the extending part of the fixing member 60 is not limited to a plate shape, and may be formed in a pin shape. Also in this configuration, the same operations and effects as those of the first embodiment and the first and second modifications can be obtained.

Furthermore, as described above, by providing the fixing members 60 at the outer peripheral edge of the magnetic recording medium 30 such that the angle formed between the adjacent fixing members 60 is 100° or less, it is possible to suppress destruction of the magnetic recording medium 30 due to application of the external force. Therefore, by providing, for example, five pieces of the fixing members 60, damage and destruction of the magnetic recording medium 30 can be further suppressed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, in the disk device, the number of pieces of magnetic disks and magnetic heads can be increased as necessary, and the size of the magnetic disk can be variously selected.

What is claimed is:

1. A disk device comprising:
a base including a bottom wall and a side wall erected along a peripheral edge of the bottom wall and having a first corner and a second corner;
a drive motor provided on the bottom wall;
a plurality of disk-shaped magnetic recording media that are supported and rotated by the drive motor;
a carriage comprising a head and supporting the magnetic head to be movable with respect to the magnetic recording medium; and
a plurality of fixing members that each include a support post erected on the bottom wall and facing an outer peripheral edge of the magnetic recording medium, and a plurality of extending parts each extending from the support post between the magnetic recording media and facing the magnetic recording medium with a gap, the fixing members including: a first fixing member provided between the outer peripheral edge of the magnetic recording medium and the first corner; a second fixing member provided between the outer peripheral edge of the magnetic recording medium and the second corner; and a third fixing member provided on a side facing the first fixing member across the magnetic recording medium.

2. The disk device of claim 1 wherein
the fixing members include a fixing member which serves as a spoiler.

3. The disk device of claim 1 wherein
the fixing members include a fixing member which serves as a filter holder.

4. The disk device of claim 1 wherein
the fixing members include a fixing member which serves as a ramp member configured to hold the head at an unload position.

5. The disk device of claim 1 wherein
the fixing members include at least one fixing member provided with a fixed part having a through hole and formed integrally with the support post, and the fixed part is screwed and fixed to the bottom wall by a fixing screw inserted through the through hole.

6. The disk device of claim 1 wherein
the disk-shaped magnetic recording media include ten or more magnetic disks.

7. A disk device comprising:
a base including a bottom wall and a side wall standing along a peripheral edge of the bottom wall;
a drive motor provided on the bottom wall;
a plurality of disk-shaped magnetic recording media supported and rotated by the drive motor;
a carriage comprising a head and supporting the head to be movable with respect to the magnetic recording medium; and
a plurality of fixing members that each include a support post erected on the bottom wall between the side wall and an outer peripheral edge of the magnetic recording medium, and a plurality of extending parts each extending from the support post between the magnetic recording media and facing the magnetic recording medium with a gap, the fixing members including:
a first fixing member;
a second fixing member provided to be spaced apart from the first fixing member in a circumferential direction of the magnetic recording medium and arranged such that an angle formed with the first fixing member is 120° or less;
a third fixing member provided between the first fixing member and the second fixing member in the circumferential direction and arranged such that an angle formed with the second fixing member is 120° or less; and
a fourth fixing member provided between the first fixing member and the third fixing member in the circumferential direction and arranged such that an angle formed with the first fixing member is 120° or less, and an angle formed with the third fixing member is 120° or less.

8. The disk device of claim 7, wherein
an angle formed by a straight line connecting the first fixing member and a center of the magnetic recording medium and a straight line connecting the second fixing member and the center of the magnetic recording medium is 120° or less,
an angle formed by a straight line connecting the second fixing member and the center of the magnetic recording medium and a straight line connecting the third fixing member and the center of the magnetic recording medium is 120° or less, and
an angle formed by a straight line connecting the third fixing member and the center of the magnetic recording medium and a straight line connecting the fourth fixing member and the center of the magnetic recording medium is 120° or less.

9. The disk device of claim 8, wherein
the fixing members are disposed such that each of the angle formed by the first fixing member and the second fixing member, the angle formed by the second fixing member and the third fixing member, and the angle formed by the third fixing member and the fourth fixing member is 100° or less.

10. The disk device of claim 7, wherein
the fixing members include a fixing member which serves as a spoiler.

11. The disk device of claim 7, wherein
the fixing members include a fixing member which serves as a filter holder.

12. The disk device of claim 7, wherein
the fixing members include a fixing member which serves as a ramp member configured to hold the head at an unload position.

13. The disk device of claim 7, wherein
the fixing members include at least one fixing member provided with a fixed part having a through hole and formed integrally with the support post, and the fixed part is screwed and fixed to the bottom wall by a fixing screw inserted through the through hole.

14. The disk device of claim 7, wherein
the disk-shaped magnetic recording media include ten or more magnetic disks.
